(19) United States
(12) Patent Application Publication
(10) Pub. No.: US 2025/0350330 A1
(43) Pub. Date: Nov. 13, 2025

(54) BEAMSPACE EQUALIZATION WITH INTERNAL SPATIALLY DIVERSE TEST TARGETS

(71) Applicant: Raytheon Company, Tewksbury, MA (US)

(72) Inventors: Satsuki Takahashi-Green, Redondo Beach, CA (US); Clarence S. Johnson, JR., Los Angeles, CA (US)

(21) Appl. No.: 18/658,796

(22) Filed: May 8, 2024

(51) Int. Cl. H04B 7/06; H04B 7/005; H04B 17/11

(52) U.S. Cl. CPC H04B 7/0617; H04B 7/005; H04B 17/11

(57) ABSTRACT

An apparatus includes a receiver. The receiver includes a plurality of receive channels, and each of the receive channels is configured to receive a radio frequency (RF) signal. The apparatus also includes at least one processing device configured to perform pulse compression on a plurality of RF signals received via the plurality of receive channels and generate pulse-compressed RF signals. The at least one processing device is also configured to perform Doppler filtering on the pulse-compressed RF signals and generate Doppler-filtered RF signals, convert the Doppler-filtered RF signals into a plurality of beams using beamforming, and apply an equalization weight from a plurality of equalization weights to each beam of the plurality of beams.

### TECHNICAL FIELD

This disclosure generally relates to radio frequency (RF) systems. More specifically, this disclosure relates to methods and apparatuses for performing beamspace equalization with internal spatially diverse test targets.

### BACKGROUND

Various radio frequency (RF) systems, such as radar and wireless telecommunications systems, utilize beamforming techniques to identify target locations, identify locations of user equipment, or perform other functions. For example, a radar system may utilize an array of antenna elements to detect reflections from a radar target and calculate the target's location based on RF signals received at different antenna elements, which may be beamformed to improve directionality, gain, etc.

### SUMMARY

This disclosure relates to methods and apparatuses for performing beamspace equalization with internal spatially diverse test targets.

In a first embodiment, an apparatus includes a receiver. The receiver includes a plurality of receive channels, and each of the receive channels is configured to receive a radio frequency (RF) signal. The apparatus also includes at least one processing device configured to perform pulse compression on a plurality of RF signals received via the plurality of receive channels and generate pulse-compressed RF signals. The at least one processing device is also configured to perform Doppler filtering on the pulse-compressed RF signals and generate Doppler-filtered RF signals, convert the Doppler-filtered RF signals into a plurality of beams using beamforming, and apply an equalization weight from a plurality of equalization weights to each beam of the plurality of beams.

In a second embodiment, a method includes receiving a plurality of RF signals using a plurality of receive channels of a receiver. The method also includes performing pulse compression on the plurality of RF signals to generate pulse-compressed RF signals. The method further includes performing Doppler filtering on the pulse-compressed RF signals to generate Doppler-filtered RF signals. In addition, the method includes converting the Doppler-filtered RF signals into a plurality of beams using beamforming and applying an equalization weight from a plurality of equalization weights to each beam of the plurality of beams.

In a third embodiment, a non-transitory machine readable medium contains instructions that, when executed by at least one processor, cause the at least one processor to perform pulse compression on a plurality of RF signals received via a plurality of receive channels of a receiver to generate pulse-compressed RF signals. The non-transitory machine readable medium also contains instructions that, when executed by the at least one processor, cause the at least one processor to perform Doppler filtering on the pulse-compressed RF signals to generate Doppler-filtered RF signals. The non-transitory machine readable medium further contains instructions that, when executed by the at least one processor, cause the at least one processor to convert the Doppler-filtered RF signals into a plurality of beams using beamforming and apply an equalization weight from a plurality of equalization weights to each beam of the plurality of beams.

Other technical features may be readily apparent to one skilled in the art from the following figures, descriptions, and claims.

### BRIEF DESCRIPTION OF THE DRAWINGS

For a more complete understanding of this disclosure, reference is made to the following description, taken in conjunction with the accompanying drawings, in which:

FIG. 1 illustrates an example block diagram for element-level equalization in accordance with this disclosure;

FIG. 2 illustrates an example block diagram for beamspace equalization in accordance with this disclosure;

FIG. 3 illustrates an example block diagram for tactical weight computation for beamspace equalization in accordance with this disclosure; and

FIG. 4 illustrates an example block diagram for tactical weight application for beamspace equalization in accordance with this disclosure.

### DETAILED DESCRIPTION

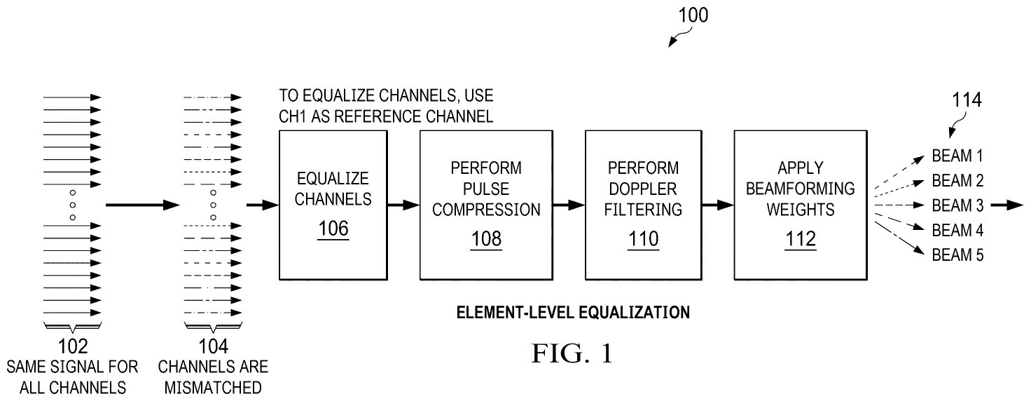

FIGS. 1 through 4, described below, and the various embodiments used to describe the principles of the present disclosure are by way of illustration only and should not be construed in any way to limit the scope of this disclosure. Those skilled in the art will understand that the principles of the present disclosure may be implemented in any type of suitably arranged device or system.

As noted above, various radio frequency (RF) systems, such as radar and wireless telecommunications systems, utilize beamforming techniques to identify target locations, identify locations of user equipment, or perform other functions. For example, a radar system may utilize an array of antenna elements to detect reflections from a radar target and calculate the target's location based on RF signals received at different antenna elements, which may be beamformed to improve directionality, gain, etc.

As a result, beamforming systems may benefit from electronic calibration. For example, while each receiving element of the beamforming system may receive an identical signal, the signals may differ in terms of when they reach the receiver for processing. This may lead to inaccurate target tracking. To improve the accuracy of the system, equalization may be performed.

FIG. 1 illustrates an example block diagram for element-level equalization 100 in accordance with this disclosure. In the example of FIG. 1, an electronic apparatus receives a plurality of RF signals 102 via a plurality of receive channels 104. As can be seen in FIG. 1, each of the RF signals 102 is an identical signal, but the signals are mismatched when received by the plurality of receive channels 104. To compensate for the mismatch, a processor uses one of the receive channels as a reference channel, and equalizes the channels (block 106) such that the signal from each channel is identical before further processing. The processor then performs pulse compression on the equalized RF signals (block 108), and performs Doppler filtering on the pulse-compressed RF signals (block 110). Finally, the processor applies beamforming weights (block 112) to the Doppler-filtered RF signals to generate a plurality of beams 114. While beams 114 are illustrated as beams 1-5, it should be understood that any number of beams may be generated from the plurality of RF signals.

Although FIG. 1 illustrates one example of a block diagram for element-level equalization 100, various changes may be made to FIG. 1. For example, the number of receive channels may vary, the number of beams generated may vary, additional processing steps could be performed, etc. according to various needs.

While element-level equalization is an effective technique for calibrating a beamforming system, element-level equalization is operationally complex. Element-level equalization utilizes significant frontend processing resources in typical applications, as a typical beamforming system may perform equalization on thousands of elements. The processing cost for equalization can be computed with respect to total DSP slices where:

Total DSP slices=(EQ Taps)×(#of total elements/beams)×(DSP slices per Complex Tap)

For instance, a narrowband system may utilize 13 element-level equalizer taps per element, and have 1024 dual-polarization elements, with each tap utilizing 3 DSP slices. In this scenario, element-level equalization would utilize 79,872 DSP total slices in total. For a wideband system, element-level equalization is even more operationally, complex. For instance, a wideband system may utilize 19 equalizer taps per element, and have 1024 dual-polarization elements, with each tap utilizing 3 DSP slices. In this scenario, element-level equalization would utilize 116,736 DSP slices in total. Therefore, a method of calibration that does not perform equalization for every receive element is desirable.

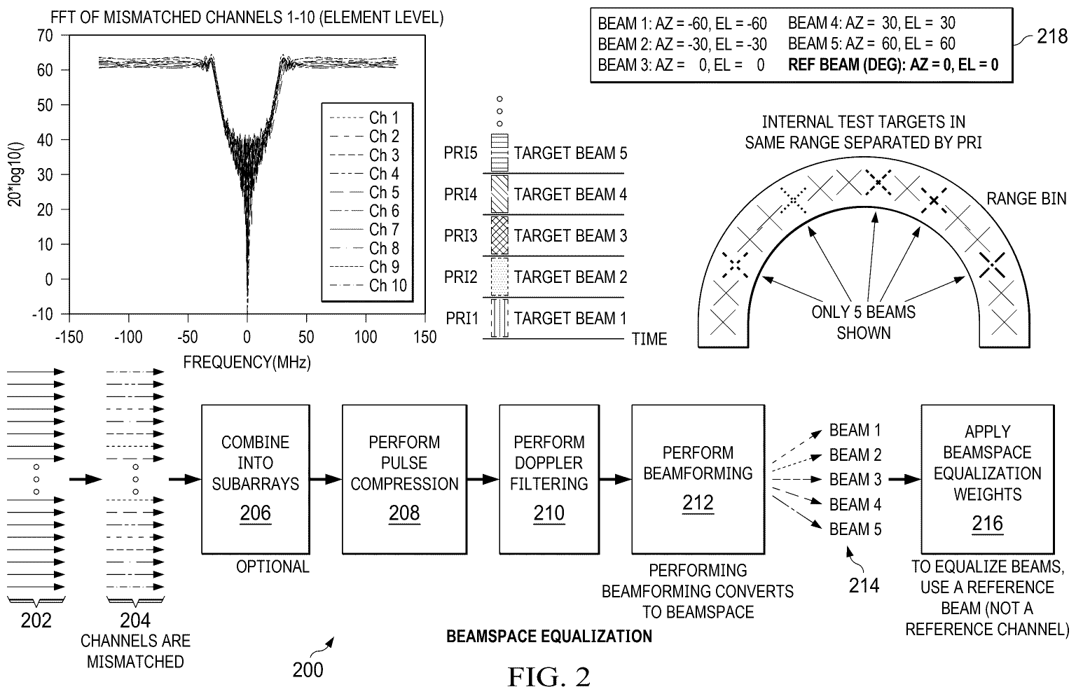

The present disclosure provides a beamspace equalization process that utilizes significantly less processing resources in typical applications. Reduced variation in combined phase for beamspace equalization leads to fewer equalization taps. For example, in the narrowband scenario above, assuming 100 dual-polarization beams, beamspace equalization may utilize 11 equalizer taps per beam, utilizing 6600 DSP slices in total. This is a reduction of over 73,000 slices. For the wideband scenario above, the reduction in processing resources is even more significant. For example, beamspace equalization with 100 dual-polarization beams may utilize 13 equalizer taps per beam, utilizing 7,800 DSP slices in total. This is a reduction of nearly 109,000 DSP slices. An example beamspace equalization process is shown in FIG. 2.

FIG. 2 illustrates an example block diagram for beamspace equalization 200 in accordance with this disclosure. In the example of FIG. 2, an electronic apparatus receives a plurality of RF signals 202 via a plurality of receive channels 204. As can be seen in FIG. 2, each of the RF signals 202 is an identical signal, but the signals are mismatched when received by the plurality of receive channels 204. In some embodiments, at block 206, the RF signals 202 may be optionally combined into a plurality of subarrays. However, for ease of explanation, a subarray and an individual RF signal are treated interchangeably for processing purposes with respect to FIG. 2. The processor then performs pulse compression on the equalized RF signals/subarrays (block 208) and performs Doppler filtering on the pulse-compressed RF signals/subarrays (block 210). The processor beamforming (block 212) to the Doppler-filtered RF signals to generate a plurality of beams 214. This converts the RF signals into beamspace. While beams 214 are illustrated as beams 1-5, it should be understood that any number of beams may be generated from the plurality of RF signals. Finally, at block 216, the processor applies beamspace equalization weights based on a reference beam to the beams so that the beams have the same frequency response as the frequency response of the reference beam. As shown in FIG. 2., the reference beam has an azimuth of 0 and an elevation of 0, and the internal test targets for beams 1-5 correspond with table 218. For instance, an equalization weight is applied to beam 1 so that the frequency response of beam 1 is the same as the frequency response of the reference beam.

Although FIG. 2 illustrates one example of a block diagram for beamspace equalization 200, various changes may be made to FIG. 2. For example, the number of receive channels may vary, the number of beams generated may vary, the azimuth and elevation angles of the reference beams may vary, additional processing steps could be performed, etc. according to various needs.

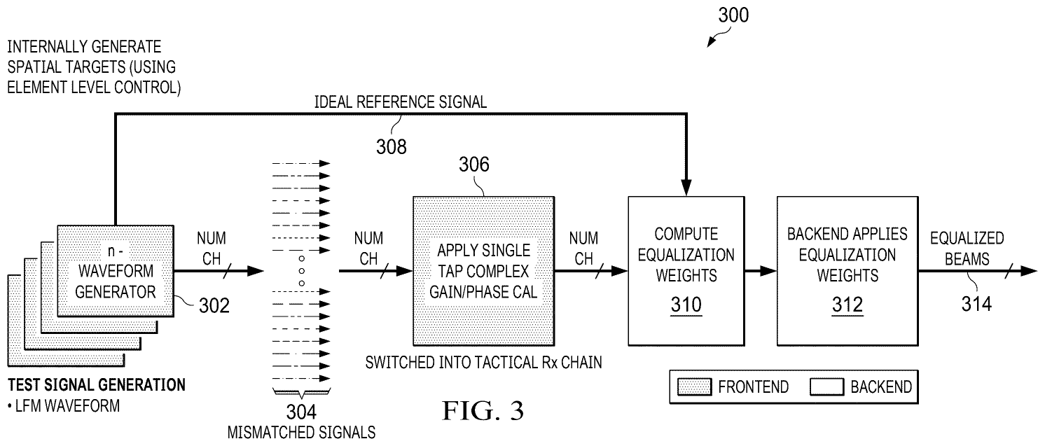

In some embodiments where beamspace equalization is utilized, an electronic system (such as a radar system) may include internal waveform generators. These waveform generators may be used to generate internal spatial targets in the electronic which may be utilized to test and calibrate the electronic system. For example, the internally generated spatial targets may be utilized to compute the equalization weights that are later applied during the beamspace equalization process. This may be referred to as tactical weight computation. An example of tactical weight computation is shown in FIG. 3.

FIG. 3 illustrates an example block diagram for tactical weight computation for beamspace equalization 300 in accordance with this disclosure. In the example of FIG. 3, an electronic apparatus generates a plurality of RF signals 304 via a plurality of waveform generator channels 302. As can be seen in FIG. 3, RF signals 304 are mismatched. For example, the signals may represent the expected output of a receive element when receiving a beam with particular characteristics (such as a target at a particular location). The mismatched RF signals 304 are switched into the input of a tactical receive chain and received by a plurality of receive channels. At block 306, a processor performs a single-tap complex gain/phase calibration on RF signals 304. An additional waveform generator channel generates an ideal reference signal 308, and at block 310 the processor computes the equalization weights for beamspace equalization based on ideal reference signal 308 and the complex gain/phase calibration of RF signals 304. While reference signal 308 is shown as being generated by a waveform generator channel in the example of FIG. 3, it should be understood that reference signal 308 may be generated by any source. For example, reference signal 308 may be generated by the processor based on digital reference data stored within a memory. At block 312, the processor applies the equalization weights to generate a plurality of equalized beams 314 similar as described with respect to FIG. 2.

Although FIG. 3 illustrates one example of a block diagram for tactical weight computation for beamspace equalization 300, various changes may be made to FIG. 3. For example, a single waveform generator with element-level phase/gain/time-delay control may be utilized, the number of receive channels may vary, the number of beams generated may vary, additional processing steps could be performed, etc. according to various needs.

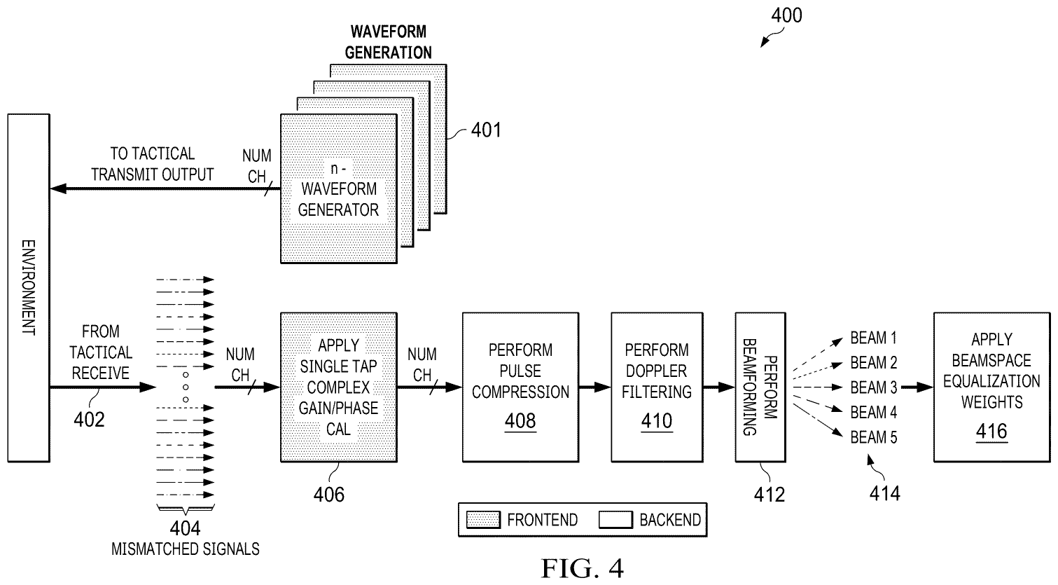

As previously described, in some embodiments where beamspace equalization is utilized, an electronic system (such as a radar system) may include internal waveform generators which may be used to generate transmit waveforms. For example, the transmit waveforms may be output from a tactical transmit output into the free space environment. The reflected energy from the environment (including actual targets) may be received from a tactical receive chain, and previously computed equalization weights may be applied to the received signal. The resulting equalized beams can then be analyzed to confirm detection of any targets from the environment. This may be referred to as tactical weight application. An example of tactical weight application is shown in FIG. 4.

FIG. 4 illustrates an example block diagram for tactical weight application for beamspace equalization 400 in accordance with this disclosure. In the example of FIG. 4, an electronic apparatus generates a plurality of RF signals 404 via a plurality of waveform generators 401. The plurality of RF signals is output to the free space environment. The reflected energy from the free space environment is received by a plurality of receivers in a tactical receive chain 402. As can be seen in FIG. 4, RF signals 404 are mismatched. For example, the signals may represent the expected output of a receive element when receiving a beam with particular characteristics (such as a target at a particular location). At block 406, a processor performs a single-tap complex gain/phase calibration on RF signals 404. The processor then performs pulse compression on the gain/phase calibrated RF signals (block 408) and performs Doppler filtering on the pulse-compressed RF signals (block 410). The processor performs beamforming (block 412) on the Doppler-filtered RF signals to generate a plurality of beams 414. This converts the RF signals into beamspace. While beams 414 are illustrated as beams 1-5, it should be understood that any number of beams may be generated from the plurality of RF signals. Finally, at block 416, the processor applies beamspace equalization weights that were previously calculated. For example, the equalization weights may be based on a reference beam similar as described regarding FIG. 2, or calculated based on an ideal reference signal and a test signal similar as described regarding FIG. 3.

Although FIG. 4 illustrates one example of a block diagram for tactical weight application for beamspace equalization 400, various changes may be made to FIG. 4. For example, the number of receive channels may vary, the number of beams generated may vary, additional processing steps could be performed, etc. according to various needs.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable storage device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present disclosure should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. An apparatus comprising:
a receiver comprising a plurality of receive channels, each of the receive channels configured to receive a radio frequency (RF) signal; and
at least one processing device configured to:
perform pulse compression on a plurality of RF signals received via the plurality of receive channels and generate pulse-compressed RF signals;
perform Doppler filtering on the pulse-compressed RF signals and generate Doppler-filtered RF signals;
convert the Doppler-filtered RF signals into a plurality of beams using beamforming; and
apply an equalization weight from a plurality of equalization weights to each beam of the plurality of beams.

2. The apparatus of claim 1, wherein the at least one processing device is configured to:
combine the plurality of RF signals into a plurality of subarrays;
perform the pulse compression on the plurality of subarrays to generate pulse-compressed subarrays;
perform the Doppler filtering on the pulse-compressed subarrays to generate Doppler-filtered subarrays; and
convert the Doppler-filtered subarrays into the plurality of beams using beamforming.

3. The apparatus of claim 1, wherein the at least one processing device is further configured to apply single-tap complex gain/phase calibration to the plurality of RF signals received from the plurality of receive channels prior to performing the pulse compression.

4. The apparatus of claim 3, further comprising:
a plurality of waveform generator channels, each of the waveform generator channels configured to output an RF signal to one of the plurality of receive channels; and
a reference signal generator configured to output a reference signal;
wherein the reference signal generator comprises at least one of:
an additional waveform generator channel; and
digital reference signal data stored within a memory; and
wherein the at least one processing device is configured to determine the plurality of equalization weights based on the reference signal and the plurality of RF signals received from the plurality of receive channels.

5. The apparatus of claim 4, wherein the RF signals of the plurality of RF signals received via the plurality of receive channels are mismatched.

6. The apparatus of claim 3, further comprising:
a tactical transmit output configured to transmit a plurality of RF signals into a free space environment;
a tactical receive input configured to receive the plurality of RF signals reflected from the free space environment; and
a plurality of waveform generator channels, each of the waveform generator channels configured to output an RF signal via the tactical transmit output;
wherein the receive channels are configured to receive the plurality of RF signals from the tactical receive input.

7. A method comprising:
receiving a plurality of RF signals using a plurality of receive channels of a receiver;
performing pulse compression on the plurality of RF signals to generate pulse-compressed RF signals;
performing Doppler filtering on the pulse-compressed RF signals to generate Doppler-filtered RF signals;
converting the Doppler-filtered RF signals into a plurality of beams using beamforming; and
applying an equalization weight from a plurality of equalization weights to each beam of the plurality of beams.

8. The method of claim 7, wherein the equalization weights are based on at least one of:
a reference beam; and
digital reference signal data stored within a memory.

9. The method of claim 7, further comprising:
combining the plurality of RF signals into a plurality of subarrays;
wherein:
the pulse compression is performed on the plurality of subarrays to generate pulse-compressed subarrays;
the Doppler filtering is performed on the pulse-compressed subarrays to generate Doppler-filtered subarrays; and
the Doppler-filtered subarrays are converted into the plurality of beams using beamforming.

10. The method of claim 7, further comprising:
applying a single-tap complex gain/phase calibration to the plurality of RF signals received from the plurality of receive channels prior to performing the pulse compression.

11. The method of claim 10, further comprising:
outputting RF signals from a plurality of waveform generator channels into the plurality of receive channels;
outputting a reference signal generated from at least one of:
an additional waveform generator channel; and
digital reference signal data stored within a memory;
determining the plurality of equalization weights based on the reference signal and the plurality of RF signals received from the plurality of receive channels.

12. The method of claim 11, wherein the RF signals of the plurality of RF signals received via the plurality of receive channels are mismatched.

13. The method of claim 10, further comprising:
transmitting an RF signal from at least one of a plurality of waveform generator channels via a tactical transmit output into a free space environment; and
receiving, via a tactical receive input, the RF signal from the at least one of the plurality of waveform generator channels reflected from the free space environment, wherein the RF signals received from the plurality of receive channels are received from the tactical receive input.

14. A non-transitory machine readable medium containing instructions that, when executed by at least one processor, cause the at least one processor to:
perform pulse compression on a plurality of RF signals received via a plurality of receive channels of a receiver to generate pulse-compressed RF signals;
perform Doppler filtering on the pulse-compressed RF signals to generate Doppler-filtered RF signals;
convert the Doppler-filtered RF signals into a plurality of beams using beamforming; and
apply an equalization weight from a plurality of equalization weights to each beam of the plurality of beams.

15. The non-transitory machine readable medium of claim 14, wherein the equalization weights are based on at least one of:
a reference beam; and
digital reference signal data stored within a memory.

16. The non-transitory machine readable medium of claim 14, further containing instructions that, when executed by the at least one processor, cause the at least one processor to combine the plurality of RF signals into a plurality of subarrays;
wherein the instructions when executed cause the at least one processor to:
perform the pulse compression on the plurality of subarrays to generate pulse-compressed subarrays;
perform the Doppler filtering on the pulse-compressed subarrays to generate Doppler-filtered subarrays; and
convert the Doppler-filtered subarrays into the plurality of beams using beamforming.

17. The non-transitory machine readable medium of claim 14, further containing instructions that, when executed by the at least one processor, cause the at least one processor to apply a single-tap complex gain/phase calibration to the plurality of RF signals received from the plurality of receive channels prior to performing the pulse compression.

18. The non-transitory machine readable medium of claim 17, further containing instructions that, when executed by the at least one processor, cause the at least one processor to:
output RF signals from a plurality of waveform generator channels into the plurality of receive channels;
output a reference signal generated from at least one of:
an additional waveform generator channel; and
digital reference signal data stored within a memory;
determine the plurality of equalization weights based on the reference signal and the plurality of RF signals received from the plurality of receive channels.

19. The non-transitory machine readable medium of claim 18, wherein the RF signals of the plurality of RF signals received via the plurality of receive channels are mismatched.

20. The non-transitory machine readable medium of claim 17, further containing instructions that, when executed by the at least one processor, cause the at least one processor to:
transmit an RF signal from at least one of a plurality of waveform generator channels via a tactical transmit output into a free space environment; and
receive, via a tactical receive input, the RF signal from the at least one of the plurality of waveform generator channels reflected from the free space environment, wherein the RF signals received from the plurality of receive channels are received from the tactical receive input.
